(19) United States
(12) Patent Application Publication
(10) Pub. No.: US 2026/0090525 A1
(43) Pub. Date: Apr. 2, 2026

(54) Liquid Dispensing External Top Feeder

(71) Applicants: Gary W. Drumright, Ashland City, TN (US); Cory M. Drumright, Clarksville, TN (US)

(72) Inventors: Gary W. Drumright, Ashland City, TN (US); Cory M. Drumright, Clarksville, TN (US)

(21) Appl. No.: 19/343,531

(22) Filed: Sep. 29, 2025

Related U.S. Application Data
(60) Provisional application No. 63/702,182, filed on Oct. 2, 2024.

(51) Int. Cl. A01K 53/00

(52) U.S. Cl. CPC A01K 53/00

(57) ABSTRACT

A liquid dispensing top feeder device for beekeeping applications comprises a base plate having a central opening, a riser configured to attach to a feeding container, a dispensing plate having a plurality of holes disposed between the riser and feeding container, and a rotatable shutter that selectively exposes different amounts of the plurality of holes to control feed delivery rate. The base plate includes a groove for sealant and mounting holes for securing to a hive cover. The riser has threads for engaging feeding containers and a flared base resting on the base plate. The shutter comprises a circular disk with a semicircular opening that varies overlap with the holes through rotation. The device accommodates mason jars and buckets, providing adjustable liquid feed delivery to honey bee colonies while preventing moisture intrusion into the hive environment.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### FIELD OF INVENTION

The present disclosure relates to liquid dispensing devices for beekeeping, and more particularly to an adjustable liquid dispensing top feeder with a shutter mechanism for controlling the delivery rate of liquid feed to honey bee colonies.

### BACKGROUND

Beekeeping has been practiced for thousands of years, with modern apiarists relying on various feeding methods to support honey bee colonies during periods when natural nectar sources are limited. Supplemental feeding becomes particularly useful during seasonal transitions, when establishing new colonies, or when natural forage is insufficient to maintain colony health and productivity.

Traditional feeding methods for honey bee colonies include several approaches, each with distinct characteristics and applications. Internal feeding systems typically involve placing feed containers or reservoirs within the hive structure itself, often requiring the beekeeper to open the hive and potentially disturb the colony during feeding operations. External feeding approaches place feed sources outside the hive, allowing bees to access nutrition without direct hive intrusion.

Top feeding systems represent one category of external feeding methods, where feed containers are positioned above the hive structure. These systems generally utilize containers with perforated lids or caps that allow controlled access to liquid feed such as sugar-water mixtures. The feed delivery rate in conventional systems is typically determined by the size and number of perforations in the feeding interface, with limited ability to adjust flow rates without physically modifying or replacing components.

Colony feeding requirements can vary considerably based on factors such as colony strength, seasonal conditions, available natural forage, and specific management objectives. Different colonies may benefit from different feeding rates, and the same colony may require varying feed delivery rates at different times. The ability to control and adjust feeding rates can influence colony behavior, development patterns, and overall management efficiency.

Moisture management represents another consideration in hive feeding systems. Excess moisture within hive environments can contribute to various problems including mold growth, condensation issues, and other conditions that may affect colony health. Feeding systems that minimize moisture intrusion while maintaining effective feed delivery can contribute to better hive environmental conditions.

Current feeding approaches often involve fixed delivery rates or require component replacement or modification to achieve different flow characteristics. This can result in increased labor requirements for beekeepers and may limit the precision with which feeding programs can be implemented across different colonies or changing conditions.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a liquid dispensing top feeder device is provided. The device includes a base plate having a central opening. The device includes a riser configured to attach to a feeding container. The device includes a dispensing plate having a plurality of holes and configured to be disposed between the riser and the feeding container. The device includes a shutter disposed beneath the dispensing plate and the riser, so that the shutter is adjacent the dispensing plate, and wherein the shutter is rotatable to selectively expose different amounts of the plurality of holes in the dispensing plate to control a feed delivery rate.

According to other aspects of the present disclosure, the liquid dispensing top feeder device may include one or more of the following features. The base plate may comprise a groove configured to receive a sealant. The base plate may be hexagonal in shape and may comprise a plurality of mounting holes spaced around the base plate for securing the base plate to the hive cover. The riser may comprise a cylindrical portion having threads configured to engage with threads of the feeding container. The riser may further comprise a flared hexagonal base configured to rest on the base plate. The shutter may comprise a circular disk having an opening disposed on a first side thereof, and rotation of the shutter may vary an amount of overlap between the opening and the plurality of holes in the dispensing plate. The opening in the shutter may be semicircular in shape.

According to another aspect of the present disclosure, a liquid dispensing top feeder device is provided. The device includes a base plate having a central opening and configured to mount on a hive cover. The device includes an adapter plate disposed around the base plate. The device includes a nut configured to be inserted into a feeding container. The device includes a cap having a plurality of holes and configured to attach to the nut. The device includes a shutter disposed between the cap and the nut, wherein the shutter is rotatable to selectively expose different amounts of the plurality of holes in the cap to control a feed delivery rate.

According to other aspects of the present disclosure, the liquid dispensing top feeder device may include one or more of the following features. The base plate may comprise a groove configured to receive a sealant for creating a watertight seal with the hive cover. The base plate may be hexagonal in shape and may comprise a plurality of mounting holes spaced around the base plate for securing the base plate. The adapter plate may be cylindrical in shape and may comprise a raised exterior edge around a perimeter thereof. The adapter plate may comprise a first hexagonal opening in a base of the adapter plate connected to the raised exterior edge by a pattern of openings. The nut may comprise a cylindrical shape with a flared base having fins disposed around the flared base. The cap may be cylindrical in shape and may comprise fins disposed around edges of the cap, and the cap may comprise threads configured to engage with corresponding threads of the nut.

According to another aspect of the present disclosure, a method of using a liquid dispensing top feeder device is provided. The method includes mounting a base plate having a central opening to a hive cover. The method includes attaching a riser to a feeding container with a dispensing plate having a plurality of holes disposed between the riser and the feeding container. The method includes positioning a shutter beneath the dispensing plate and the riser. The method includes rotating the shutter to expose a desired number of the plurality of holes in the dispensing plate. The method includes inverting the feeding container and placing it on the base plate to dispense liquid feed at a controlled rate.

According to other aspects of the present disclosure, the method may include one or more of the following features. Mounting the base plate may comprise drilling a one-inch hole in the hive cover and applying sealant in a groove on a bottom of the base plate before securing the base plate to the hive cover. The feeding container may be a mason jar and attaching the riser may comprise threading the riser onto the mason jar to secure the dispensing plate and shutter beneath the mason jar and the riser. The method may further comprise a step of filling the feeding container with a sugar-water mixture before attaching the riser. The feeding container may be a bucket and the method may further comprise drilling a hole in a bucket lid, inserting a nut through the bucket lid hole with sealant, and attaching a cap having the plurality of holes to the nut with the shutter positioned between the cap and the nut. The method may further comprise a step of positioning an adapter plate around the base plate before placing the feeding container on the base plate.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates an isometric view of a liquid dispensing top feeder device, according to aspects of the present disclosure.

FIG. 2A illustrates an isometric view of a base plate top for the liquid dispensing top feeder device of FIG. 1, according to aspects of the present disclosure.

FIG. 2B illustrates an isometric view of a base plate bottom for the liquid dispensing top feeder device of FIG. 1, according to the aspects of the present disclosure.

FIG. 3 illustrates an isometric view of a riser for the liquid dispensing top feeder device of FIG. 1, according to aspects of the present disclosure.

FIG. 4 illustrates a bottom view of a shutter for the liquid dispensing top feeder device of FIG. 1, according to aspects of the present disclosure.

FIG. 5 illustrates an isometric view of a plug for the liquid dispensing top feeder device of FIG. 1, according to aspects of the present disclosure.

FIG. 6 illustrates an isometric view of a nut for the liquid dispensing top feeder device of FIG. 1, according to aspects of the present disclosure.

FIG. 7 illustrates an isometric view of a cap for the liquid dispensing top feeder device of FIG. 1, according to aspects of the present disclosure.

FIG. 8 illustrates an exploded view of the liquid dispensing top feeder device of FIG. 1, according to aspects of the present disclosure.

FIG. 9 illustrates an isometric view of the liquid dispensing top feeder device of FIG. 1 with an adapter plate, according to aspects of the present disclosure.

FIG. 10 illustrates an isometric view of the liquid dispensing top feeder device with bucket feeder configuration components, according to aspects of the present disclosure.

FIG. 11 illustrates an isometric view of the liquid dispensing top feeder device with bucket feeder configuration showing the cap and nut assembly with shutter positioning, according to aspects of the present disclosure.

FIG. 12 illustrates an isometric view of the liquid dispensing top feeder device showing the base plate with adapter plate and bucket feeder components in exploded arrangement, according to aspects of the present disclosure.

FIG. 13 illustrates an isometric view of the liquid dispensing top feeder device showing the base plate with adapter plate and bucket feeder components in exploded arrangement, according to aspects of the present disclosure.

FIG. 14 illustrates a top view of an example hive cover surface prior to installation of the top feeder device, according to aspects of the present disclosure.

FIG. 15 illustrates the base plate mounted to a hive cover with fasteners installed through the mounting holes, according to aspects of the present disclosure.

FIG. 16 illustrates the base plate with the plug installed to seal the central opening when the feeder is not in use, according to aspects of the present disclosure.

FIG. 17 illustrates an isometric view of the mason jar feeder configuration with riser, according to aspects of the present disclosure.

FIG. 18 illustrates a sectional view of the mason jar feeder configuration showing the internal components, according to aspects of the present disclosure.

FIG. 19 illustrates a top view of the base plate with the adapter plate, according to aspects of the present disclosure.

FIG. 20 illustrates the bucket feeder configuration with the feeding container positioned on the adapter plate and base plate assembly, according to aspects of the present disclosure.

FIG. 21 illustrates a sectional view of the bucket feeder configuration showing the internal components, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

References in the specification to “one embodiment,” “an embodiment,” “an example embodiment,” “one aspect,” “an aspect,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments, whether or not explicitly described.

Reference will now be made in detail to embodiments of the present disclosure, one or more examples of which are illustrated in the accompanying drawings. Each embodiment is provided by way of explanation of the present disclosure and not limitation. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

The present disclosure relates to a liquid dispensing top feeder device for use in beekeeping applications. The liquid dispensing top feeder device may be configured to provide controlled delivery of liquid feed, such as sugar-water mixtures, to honey bee colonies. In some aspects, the liquid dispensing top feeder device may address limitations found in conventional feeding systems by providing adjustable feed rates and improved moisture control. The liquid dispensing top feeder device may be particularly useful during periods when natural nectar sources are scarce and supplemental feeding becomes beneficial for colony health and productivity.

The liquid dispensing top feeder device may comprise multiple components that work together to provide controlled liquid dispensing functionality. These components may include structural elements for mounting the device to a hive cover, mechanisms for controlling feed flow rates, and interfaces for connecting various types of feeding containers. In some aspects, the liquid dispensing top feeder device may be compatible with different container types, including mason jars and plastic buckets, providing flexibility for beekeepers with varying preferences and operational requirements. The modular design of the liquid dispensing top feeder device may allow for easy assembly, disassembly, and maintenance while providing reliable performance across different environmental conditions.

The liquid dispensing top feeder device may incorporate an adjustable shutter mechanism that enables precise control over feed delivery rates. This mechanism may allow beekeepers to fine-tune the amount of liquid feed available to the colony at any given time, supporting more effective colony management practices. In some cases, the ability to adjust feed rates may help prevent overstimulation of the colony while ensuring adequate nutrition is provided when needed. The liquid dispensing top feeder device may also include sealing features designed to create watertight connections that help prevent moisture from entering the hive environment, thereby supporting optimal hive conditions for bee health and productivity.

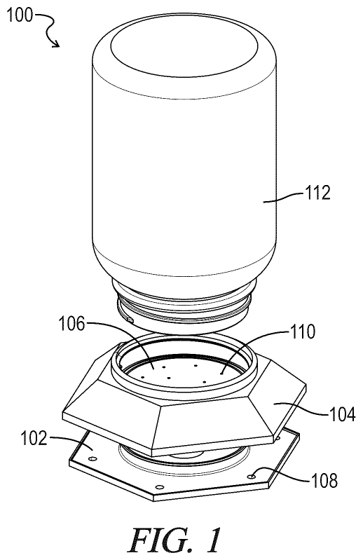

Referring to FIG. 1, a liquid dispensing top feeder device 100 may be configured for use in beekeeping applications to provide controlled delivery of liquid feed to honey bee colonies. The liquid dispensing top feeder device 100 may comprise multiple components that work together to enable adjustable feed delivery rates while maintaining secure mounting to hive structures. In some cases, the liquid dispensing top feeder device 100 may be designed to address limitations found in conventional feeding systems by providing beekeepers with the ability to fine-tune liquid flow rates based on colony needs and environmental conditions. The liquid dispensing top feeder device 100 may also be configured to reduce moisture intrusion into the hive, which can help maintain hive conditions for bee health and productivity.

The liquid dispensing top feeder device 100 may be compatible with various types of liquid feed containers 112, including mason jars and plastic buckets, providing flexibility for beekeepers with different operational preferences and requirements. In some aspects, this compatibility may allow beekeepers to utilize existing containers or select container types based on factors such as capacity, cost, or availability. The modular design of the liquid dispensing top feeder device 100 may facilitate easy assembly and disassembly, enabling efficient maintenance and cleaning operations. The liquid dispensing top feeder device 100 may incorporate structural features that provide stable mounting to hive covers while allowing for controlled liquid dispensing through adjustable mechanisms.

The liquid dispensing top feeder device 100 may include a base plate 102 that provides a mounting interface for attachment to hive covers. A riser 104 may be positioned on the base plate 102 and configured to connect with feeding containers. The device 100 may include a dispensing plate 106 having a plurality of holes 110 that allow controlled liquid dispensing. As used herein, a dispensing plate refers to a plate, disk, film, whether separate or integrated (e.g., with the riser or cap) that includes one or more apertures (e.g., plurality of holes) for dispensing liquid and for cooperation with a shutter to regulate flow. Mounting holes 108 may be disposed around the base plate 102 to facilitate secure attachment to hive structures. The liquid dispensing top feeder device 100 may be designed to interface with a liquid feed container 112, such as a mason jar or plastic bucket, which may contain sugar-water mixtures or other liquid nutrition for bee colonies.

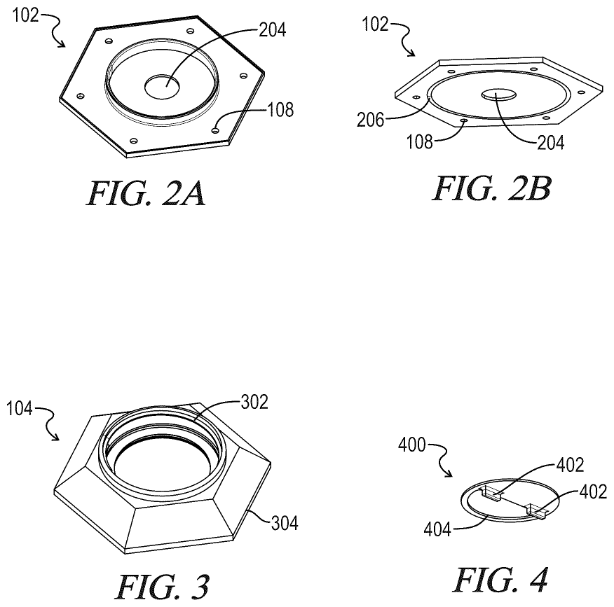

Referring to FIG. 2A, the base plate 102 may provide a mounting interface and sealing structure for the liquid dispensing top feeder device 100. The base plate 102 may be hexagonal in shape, which may provide a stable mounting configuration and facilitate alignment with hive cover structures. In some cases, the hexagonal shape of the base plate 102 may distribute mounting forces evenly across multiple attachment points, which may enhance the structural integrity of the connection between the liquid dispensing top feeder device 100 and the hive cover. In some aspects, the base plate 102 may be formed in other geometric configurations, such as circular, square, or rectangular shapes, to accommodate different hive cover designs or mounting preferences.

The base plate 102 may include a central opening 204 positioned at the center of the structure, which may allow bees to enter the liquid dispensing top feeder device 100 from the hive environment below. The central opening 204 may be sized to provide adequate access for bees while maintaining the structural strength of the base plate 102. In an embodiment, the central opening 204 may be approximately one inch in diameter.

The base plate 102 may comprise mounting holes 108 spaced around the base plate 102 for securing the base plate 102 to a hive cover. In some aspects, the mounting holes 108 may be positioned at regular intervals around the perimeter of the base plate 102, which may provide balanced attachment points for securing the base plate 102 to hive structures. The mounting holes 108 may be configured to receive fasteners such as screws or bolts, which may create a secure connection between the base plate 102 and the hive cover. In some cases, the spacing and positioning of the mounting holes 108 may be selected to distribute mounting loads across the base plate 102 and prevent localized stress concentrations that could compromise the structural integrity of the mounting interface.

With reference to FIG. 2B, the base plate 102 may comprise a groove 206 configured to receive a sealant for creating a watertight seal with the hive cover. The groove 206 may be positioned on the bottom surface of the base plate 102 and may extend circumferentially around the base plate 102 to provide a continuous sealing interface. In some aspects, the groove 206 may be configured to retain sealant materials such as caulk or other sealing compounds, which may create a moisture barrier between the base plate 102 and the hive cover. The groove 206 may have a depth and width selected to accommodate appropriate amounts of sealant, such as a quarter inch of caulk, while ensuring proper compression and sealing performance when the base plate 102 is mounted to the hive cover.

The base plate 102 may be configured to prevent any internal leakage from the hive. The configuration of the base plate 102 may create a surface that inhibits or prevents liquid from flowing into the central opening 204. In some cases, this may help prevent liquid feed from dripping directly into the hive environment, which may reduce the risk of moisture-related problems such as mold growth or other conditions that may be detrimental to bee health. The design of the base plate 102 may work in conjunction with the groove 206 to provide multiple levels of moisture protection for the hive environment. The base plate 102 may be formed of weather-resistant, UV-resistant, and heat-resistant materials that are environmentally friendly, of food-grade quality, and easily cleanable. For example, the base plate 102 may be formed using 3D printing with ASA (acrylonitrile styrene acrylate) plastic, which may provide weather resistance, UV stability, and heat resistance while maintaining food-grade compatibility for bee feeding applications. Alternatively, the base plate 102 may be formed using injection molding with HDPE (high-density polyethylene), which offers environmental resistance, UV protection, and food-grade safety for extended outdoor use in beekeeping applications.

Referring to FIG. 3, the riser 104 may provide a structural interface between the base plate 102 and the liquid feed containers 112 used with the liquid dispensing top feeder device 100. The riser 104 may be configured to attach to various types of liquid feed containers 112, such as a mason jar, providing versatility for different beekeeping applications and container preferences. In some aspects, the riser 104 may serve as a mounting mechanism that secures feeding containers in a proper position relative to the base plate 102 while maintaining controlled access to liquid feed through the dispensing plate 106 and its plurality of holes 110. The riser 104 may be designed to accommodate different container sizes and threading configurations, which may allow beekeepers to utilize existing containers or select containers based on capacity requirements and operational preferences.

The riser 104 may comprise a cylindrical portion having riser threads 302 configured to engage with the threads of the liquid feed container 112. The riser threads 302 may be positioned on the interior surface of the cylindrical portion and may be configured to mate with corresponding internal threads found on standard feeding containers such as mason jars. In some cases, the riser threads 302 may follow standard threading specifications that provide compatibility with commonly available containers, which may reduce the need for specialized or custom containers.

As further shown in FIG. 3, the riser 104 may further comprise a riser flared base 304 configured to rest on the base plate 102. The riser flared base 304 may be hexagonal in shape and provide a stable mounting interface that distributes the weight of feeding containers across the base plate 102, enhancing the structural stability of the liquid dispensing top feeder device 100 during operation. In some cases, the hexagonal configuration of the riser flared base 304 may correspond to the hexagonal shape of the base plate 102, which may provide proper alignment and positioning of the riser 104 relative to the base plate 102. In some aspects, the riser 104 may include a riser flared base 304 in alternative shapes, such as circular, square, or rectangular configurations, so long as the riser 104 is configured to attach to the base plate 102.

The riser flared base 304 may include surfaces that contact the base plate 102 to create a stable mounting configuration. In some aspects, the hexagonal shape of the riser flared base 304 may prevent rotation of the riser 104 relative to the base plate 102, which may maintain proper alignment of components during assembly and operation. The flared configuration may also provide additional surface area for load distribution, which may reduce stress concentrations at the interface between the riser 104 and the base plate 102.

The riser 104 may be positioned to interface with both the base plate 102 and the liquid feed container 112 in the assembled configuration of the liquid dispensing top feeder device 100. The riser 104 may be configured to maintain proper spacing between the base plate 102 and the liquid feed container 112, which may allow for proper positioning of the dispensing plate 106 and associated flow control components. The dispensing plate 106 may be a separate component coupled with the riser 104 or integrated into the riser 104, creating a unified assembly. The integration of the dispensing plate 106 into the riser 104 may provide a streamlined design that reduces the number of separate components while maintaining the controlled liquid dispensing functionality.

In some cases, the riser 104 may provide a mounting platform that elevates feeding containers above the base plate 102 while maintaining controlled access to the central opening 204 for bee access from the hive environment below. The riser 104 and the dispensing plate 106 may be formed of weather-resistant, UV-resistant, and heat-resistant materials that are environmentally friendly, of food-grade quality, and easily cleanable. For example, the riser 104 and the dispensing plate 106 may be formed using 3D printing with ASA (acrylonitrile styrene acrylate) plastic, which may provide weather resistance, UV stability, and heat resistance while maintaining food-grade compatibility for bee feeding applications. Alternatively, the riser 104 and the dispensing plate 106 may be formed using injection molding with HDPE (high-density polyethylene), which offers environmental resistance, UV protection, and food-grade safety for extended outdoor use in beekeeping applications.

Referring to FIG. 4, a shutter 400 may provide flow control functionality for the liquid dispensing top feeder device 100 by regulating the exposure of the plurality of holes 110 in the dispensing plate 106. The shutter 400 may comprise a circular disk having an opening disposed on a first side thereof, which may allow for controlled overlap with the plurality of holes 110 to achieve variable feed delivery rates. In some embodiments, the shutter 400 may be positioned beneath the dispensing plate 106 and the riser 104 in the assembled configuration, creating an adjustable barrier that can selectively expose different amounts of the plurality of holes 110 based on the rotational position of the shutter 400. The circular disk configuration of the shutter 400 may provide smooth rotational movement while maintaining proper alignment with adjacent components of the liquid dispensing top feeder device 100. The shutter 400 may be designed to interface with the dispensing plate 106, creating a controlled dispensing mechanism that allows beekeepers to fine-tune liquid flow rates according to colony needs and environmental conditions.

The shutter 400 may include one or more tabs 402 that facilitate manual operation and positioning of the shutter 400 relative to the plurality of holes 110 in the dispensing plate 106. The one or more tabs 402 may extend from the circular disk surface of the shutter 400, providing grip surfaces that allow beekeepers to rotate the shutter 400 to desired positions for flow control adjustment. In some aspects, the one or more tabs 402 may be positioned to provide leverage for rotating the shutter 400 while maintaining proper alignment with the dispensing plate 106. The one or more tabs 402 may be configured to remain accessible when the shutter 400 is positioned beneath the dispensing plate 106, allowing for adjustment of flow rates without requiring disassembly of the liquid dispensing top feeder device 100. The positioning and configuration of the one or more tabs 402 may facilitate precise control over the rotational position of the shutter 400, enabling beekeepers to achieve specific flow rate settings based on operational requirements.

As further shown in FIG. 4, the shutter 400 may include a semicircular opening 404 disposed on the first side of the circular disk. The semicircular opening 404 may provide a controlled aperture that can be aligned with varying portions of the plurality of holes 110 in the dispensing plate 106 through rotation of the shutter 400. In some cases, the semicircular opening 404 may be sized and positioned to provide a range of flow control options, from minimal exposure of the plurality of holes 110 to maximum exposure depending on the rotational position of the shutter 400. The semicircular configuration of the semicircular opening 404 may create a gradual transition in flow control as the shutter 400 is rotated, allowing for fine-tuned adjustment of feed delivery rates. The semicircular opening 404 may be positioned relative to the one or more tabs 402 to provide predictable and repeatable flow control settings based on the rotational position of the shutter 400.

Rotation of the shutter 400 may vary the amount of overlap between the semicircular opening 404 and the plurality of holes 110 in the dispensing plate 106, thereby controlling the feed delivery rate of the liquid dispensing top feeder device 100. When the shutter 400 is rotated to align the semicircular opening 404 with a maximum number of the plurality of holes 110 exposed, liquid feed may be accessible at a higher rate from the feeding container through the exposed holes. Conversely, when the shutter 400 is rotated to minimize the overlap between the semicircular opening 404 and the plurality of holes 110, the feed delivery rate may be reduced accordingly. In some aspects, the shutter 400 may be rotated to completely block the plurality of holes 110 when feeding is not desired, providing complete flow control capability. The rotational adjustment of the shutter 400 may allow beekeepers to respond to changing colony conditions, seasonal variations, or specific feeding protocols by modifying the feed delivery rate without replacing components or modifying the feeding container.

The shutter 400 may be formed of weather-resistant, UV-resistant, and heat-resistant materials that are environmentally friendly, of food-grade quality, and easily cleanable. For example, the shutter 400 may be formed using 3D printing with ASA (acrylonitrile styrene acrylate) plastic, which may provide weather resistance, UV stability, and heat resistance while maintaining food-grade compatibility for bee feeding applications. Alternatively, the shutter 400 may be formed using injection molding with HDPE (high-density polyethylene), which offers environmental resistance, UV protection, and food-grade safety for extended outdoor use in beekeeping applications.

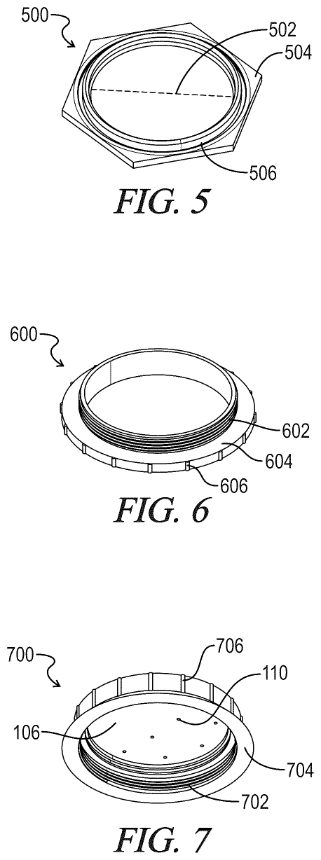

Referring to FIG. 5, a plug 500 may provide sealing functionality for the liquid dispensing top feeder device 100 when the device is not in active use. The plug 500 may be configured to seal the central opening 204 of the base plate 102, preventing unwanted access to/from the hive environment and maintaining environmental control within the hive structure. In some cases, the plug 500 may serve as a protective barrier that blocks the central opening 204 during periods when liquid feeding is not required, such as during seasonal transitions or when alternative feeding methods are being employed. The plug 500 may be designed to provide a secure fit with the base plate 102 while allowing for easy removal when feeding operations are to be resumed. The sealing function of the plug 500 may help maintain optimal hive conditions by preventing moisture intrusion, temperature fluctuations, or unwanted pest access through the central opening 204 when the liquid dispensing top feeder device 100 is not actively dispensing liquid feed.

The plug 500 may include a hexagonal plug top 504 and a cylindrical plug base 506 that work together to provide both sealing functionality and ease of handling. In some aspects, the plug top 504 may be configured in alternative geometric shapes such as octagonal, square, or other polygonal configurations that provide adequate grip surfaces for manual handling. The plug top 504 may provide grip surfaces that facilitate manual installation and removal of the plug 500 from the base plate 102. The cylindrical plug base 506 may be sized to fit within the base plate 102 and may provide the primary sealing interface between the plug 500 and the base plate 102. The cylindrical plug base 506 may be configured with dimensions that create a secure fit within the base plate 102 while allowing for reasonable installation and removal forces during normal operation, such as by hand.

As further shown in FIG. 5, the plug base 506 may include a diameter 502 that corresponds to the dimensions of the base plate 102. The diameter 502 may be selected to provide appropriate clearance for installation while maintaining effective sealing performance when the plug 500 is positioned to cover the central opening 204. In some cases, the diameter 502 may be slightly smaller than the internal diameter of the base plate 102 to allow for easy insertion, while still providing sufficient contact area for sealing purposes. The diameter 502 may be consistent along the length of the cylindrical plug base 506, creating a uniform sealing interface that distributes sealing forces evenly in connection with the base plate 102. The selection of the diameter 502 may take into account manufacturing tolerances and material properties to ensure reliable sealing performance across different environmental conditions and repeated installation cycles. In some aspects, the diameter 502 may be approximately three inches.

The plug 500 may be positioned relative to other components of the liquid dispensing top feeder device 100 to demonstrate the sealing configuration when feeding operations are not active. The plug 500 may be designed to interface directly with the base plate 102 without requiring additional components or modifications to the liquid dispensing top feeder device 100. In some aspects, the plug 500 may be stored separately when the liquid dispensing top feeder device 100 is in active use, and may be installed when feeding operations are suspended or when the device is being prepared for storage or maintenance. The plug 500 may be formed of weather-resistant, UV-resistant, and heat-resistant materials that are environmentally friendly, of food-grade quality, and easily cleanable. For example, the plug 500 may be formed using 3D printing with ASA (acrylonitrile styrene acrylate) plastic, which may provide weather resistance, UV stability, and heat resistance while maintaining food-grade compatibility for bee feeding applications. Alternatively, the plug 500 may be formed using injection molding with HDPE (high-density polyethylene), which offers environmental resistance, UV protection, and food-grade safety for extended outdoor use in beekeeping applications.

Referring to FIG. 6 and FIG. 7, the nut 600 may provide a mounting interface for connecting the liquid dispensing top feeder device 100 to bucket-type feeding containers. The nut 600 may be configured to be inserted into a liquid feed container 112, such as a bucket, creating a secure connection point that allows for controlled liquid dispensing through associated components such as the cap 700. In some cases, the nut 600 may serve as a threaded mounting element that interfaces with bucket lids or similar container closures, providing a stable platform for attaching flow control mechanisms. The nut 600 may be designed to accommodate various bucket sizes and lid configurations, which may allow beekeepers to utilize different container types based on capacity requirements and operational preferences. The structural design of the nut 600 may provide both sealing capabilities and mechanical strength to support the weight of liquid feed containers during operation.

The nut 600 may comprise a cylindrical shape with nut threads 602 configured to engage with corresponding threads of the cap 700. The nut threads 602 may be positioned on the exterior surface of the cylindrical portion of the nut 600, providing a threaded interface that allows for secure attachment of the cap 700 and associated flow control components. In some aspects, the nut threads 602 may follow standard threading specifications that provide compatibility with the cap 700, creating a reliable connection that maintains proper alignment and sealing performance during operation. The threading mechanism provided by the nut threads 602 may allow for hand-tightening of the cap 700 to the nut 600, which may facilitate assembly and disassembly operations without requiring specialized tools. The nut threads 602 may be configured to provide sufficient engagement length with the cap 700 to create a secure connection that can withstand the forces associated with inverted feeding containers and liquid pressure.

As further shown in FIG. 6, the nut 600 may comprise a nut flared base 604 having nut fins 606 disposed around the nut flared base 604. The nut flared base 604 may provide an expanded mounting surface that distributes loads across the bucket lid or container closure, which may enhance the structural stability of the connection between the nut 600 and the feeding container. In some cases, the nut flared base 604 may create a sealing interface that works in conjunction with sealant materials to prevent liquid leakage at the connection point between the nut 600 and the bucket lid, or the nut 600, the bucket lid, and the cap 700. In some aspects, sealing components such as O-rings, gaskets, washers, or caulk may be positioned between the nut flared base 604 and the bucket lid to enhance the watertight seal and prevent liquid leakage during operation. The nut fins 606, disposed around the nut flared base 604, may provide additional surface area for load distribution and may also serve as gripping features that facilitate the installation and removal of the nut 600 from bucket lids. The nut fins 606 may extend radially from the nut flared base 604, creating a series of projections that enhance the mechanical connection between the nut 600 and the bucket lid while providing improved sealing performance.

The nut 600 may be positioned to interface with the cap 700 in the assembled configuration of the liquid dispensing top feeder device 100 for bucket feeding applications. The nut threads 602 may engage with corresponding threads of the cap 700, creating a threaded connection that secures the cap 700 in a proper position relative to the liquid feed container 112. In some aspects, the threaded connection between the nut 600 and the cap 700 may allow for adjustment of the compression applied to sealing components positioned between these elements, which may optimize sealing performance and flow control functionality. The cylindrical configuration of the nut 600 may provide proper alignment with the cap 700 during assembly, ensuring that threaded engagement occurs smoothly and that all components maintain proper positioning relative to each other.

The nut 600 may incorporate sealing features that work in conjunction with sealant materials to create watertight connections during installation. In some aspects, sealant may be applied to the nut 600 after insertion through the bucket lid and before attaching the cap 700, creating a moisture barrier that prevents liquid leakage around the connection point. The sealant application may involve placing a continuous bead of sealing compound around the circumference of the nut threads 602, which may then be coupled to the cap 700. The sealant material may comprise silicone-based compounds, polyurethane sealants, or other flexible sealing materials that maintain their sealing properties under the mechanical loads and environmental conditions encountered in beekeeping applications. In some aspects, the sealant may be selected based on its compatibility with food-grade applications and its ability to maintain adhesion to plastic surfaces over extended periods of use. The application of sealant to both the nut flared base 604 and the nut threads 602 may create multiple sealing barriers that work together to prevent moisture intrusion while maintaining the structural integrity of the connection between the nut 600, bucket lid, and cap 700.

The material selection for the nut 600 may also provide appropriate flexibility for sealing applications while maintaining structural integrity under operational loads and environmental conditions. The nut 600 may be configured to maintain dimensional stability and threading performance over extended periods of use, which may reduce maintenance requirements and provide reliable operation throughout multiple feeding cycles. The nut 600 may be formed of weather-resistant, UV-resistant, and heat-resistant materials that are environmentally friendly, of food-grade quality, and easily cleanable. For example, the nut 600 may be formed using 3D printing with ASA (acrylonitrile styrene acrylate) plastic, which may provide weather resistance, UV stability, and heat resistance while maintaining food-grade compatibility for bee feeding applications. Alternatively, the nut 600 may be formed using injection molding with HDPE (high-density polyethylene), which offers environmental resistance, UV protection, and food-grade safety for extended outdoor use in beekeeping applications.

Referring to FIG. 7, the cap 700 may provide a controlled liquid dispensing interface for bucket-type feeding containers used with the liquid dispensing top feeder device 100. The cap 700 may be cylindrical in shape, which may provide structural integrity and compatibility with standard bucket lid configurations. In some cases, the cylindrical configuration of the cap 700 may facilitate proper alignment with the nut 600 during assembly operations while maintaining controlled liquid flow through the plurality of holes 110 of the cap 700. The cap 700 may serve as a mounting interface that connects to bucket-style feeding containers via the nut 600, creating a secure dispensing system that allows for adjustable feed delivery rates.

The cap 700 may comprise cap threads 702 configured to engage with corresponding nut threads 602 of the nut 600. The cap threads 702 may be positioned on the interior surface of the cylindrical portion of the cap 700, creating a threaded interface that allows for secure attachment to the nut 600. In some aspects, the cap threads 702 may follow standard threading specifications that provide reliable engagement with the nut threads 602, creating a connection that maintains proper alignment and sealing performance during operation. The threading mechanism provided by the cap threads 702 may allow for hand-tightening of the cap 700 to the nut 600, which may facilitate assembly and disassembly operations without requiring specialized tools or equipment. The cap threads 702 may be configured to provide sufficient engagement length with the nut threads 602 to create a secure connection that can withstand the forces associated with inverted feeding containers and liquid pressure encountered during normal feeding operations.

As further shown in FIG. 7, the cap 700 may comprise cap fins 706 disposed around edges of the cap 700. The cap fins 706 may extend radially from the cylindrical surface of the cap 700, creating a series of projections that provide improved gripping surfaces for manual handling during assembly and adjustment operations. The cap fins 706 may be positioned around the circumference of the cap 700, creating a uniform pattern that provides balanced gripping surfaces while maintaining the cylindrical configuration of the cap 700. The cap fins 706 may be configured with dimensions and spacing that allow for comfortable manual gripping while providing adequate structural support for the cap 700 during installation and removal operations.

The cap 700 may include a circumferential extension 704. The circumferential extension 704 may provide structural support and enhance the connection between the cap 700 and adjacent components, such as the nut 600 or feeding container lid. In some cases, the circumferential extension 704 may create an area that accommodates sealing materials or provides improved contact surfaces for creating moisture-resistant connections. The circumferential extension 704 may extend around the perimeter of the cap 700, providing a continuous sealing interface that helps prevent liquid leakage at the connection points between the cap 700 and other components of the liquid dispensing top feeder device 100.

The cap 700 may further include a plurality of holes 110, providing a controlled liquid dispensing interface for the liquid dispensing top feeder device 100, wherein the liquid feed container 112 is a bucket. In some cases, the cap 700 with a plurality of holes 110, may serve as a flow control element that works in conjunction with other components of the liquid dispensing top feeder device 100 to provide adjustable feed delivery rates. The integrated design may facilitate proper alignment between the plurality of holes 110 and other flow control components, such as the shutter 400, which may enhance the precision and reliability of feed delivery rate adjustments.

For bucket feeder configurations, the plurality of holes 110 may be integrated into the cap 700, creating a self-contained dispensing mechanism that can be attached directly to the nut 600. The integration of the plurality of holes 110 into the cap 700 may provide a compact design that incorporates both the threaded attachment interface and the controlled dispensing holes within a single component. In some aspects, the integrated cap 700 and plurality of holes 110 configuration may simplify the assembly process for bucket feeding applications while maintaining the adjustable flow control capabilities provided by the shutter 400 mechanism. The integrated design may allow the plurality of holes 110 to be positioned relative to the cap threads 702 and other structural features, which may improve flow control precision during operation.

The dispensing plate 106 and the cap 700 may have a plurality of holes 110 that allow controlled liquid dispensing from the liquid feed container 112 to the hive environment. The plurality of holes 110 may be positioned across the surface of the dispensing plate 106 or cap 700 in a pattern that provides distributed liquid flow while maintaining the structural integrity of the dispensing plate 106 and cap 700, respectively. In some aspects, the plurality of holes 110 may be sized to control the rate of liquid flow through, with hole diameter and spacing selected to provide appropriate flow characteristics for bee feeding applications. The plurality of holes 110 may be arranged in patterns that facilitate even distribution of liquid feed while preventing excessive flow rates that could lead to waste or colony overstimulation. The positioning and configuration of the plurality of holes 110 may work in conjunction with the shutter 400 to provide variable flow control capabilities. The plurality of holes 110 may be formed through manufacturing processes that maintain smooth edges and consistent dimensions, which may prevent clogging and ensure reliable liquid flow throughout extended feeding operations.

The cap 700, may be formed of weather-resistant, UV-resistant, and heat-resistant materials that are environmentally friendly, of food-grade quality, and easily cleanable. For example, the cap 700 and may be formed using 3D printing with ASA (acrylonitrile styrene acrylate) plastic, which may provide weather resistance, UV stability, and heat resistance while maintaining food-grade compatibility for bee feeding applications. Alternatively, the cap 700 may be formed using injection molding with HDPE (high-density polyethylene), which offers environmental resistance, UV protection, and food-grade safety for extended outdoor use in beekeeping applications. The material selection for the cap 700 may provide appropriate flexibility for sealing applications while maintaining structural integrity under operational loads and environmental conditions commonly encountered in beekeeping applications. The cap 700 may be configured to maintain dimensional stability and threading performance over extended periods of use, which may reduce maintenance requirements and provide reliable operation throughout multiple feeding cycles while supporting the controlled dispensing functionality provided by the liquid dispensing top feeder device 100.

In some aspects, the shutter 400 may be a separate component that is attached to the riser 104, or it may be predisposed or integrated into the riser 104 during or after manufacturing for jar feeder applications, creating a unified assembly that simplifies installation and operation. The integration of the shutter 400 into the riser 104 may allow the shutter 400 mechanism to be pre-positioned on the underside of the riser 104 and adjacent to the dispensing plate 106, which may reduce assembly steps and ensure proper alignment during installation. In some cases, the riser 104 may include internal features or channels that accommodate the shutter 400 while allowing rotational movement for flow control adjustment. For example, the shutter 400 may be attached to the riser 104 via grooves or recesses in the riser 104, which allow the shutter 400 to snap into place. The shutter 400 may also be accessed and adjusted by lifting the riser 104 off the base plate 102. Alternatively, for bucket feeder configurations, the shutter 400 may be a separate component that is attached to the cap 700, or it may be predisposed or integrated into the cap 700 during or after manufacturing, creating a self-contained flow control mechanism that can be attached directly to the liquid feed container 112 via the nut 600. The integration of the shutter 400 into the cap 700 may provide a compact design that maintains the adjustable flow control functionality while simplifying the overall assembly process.

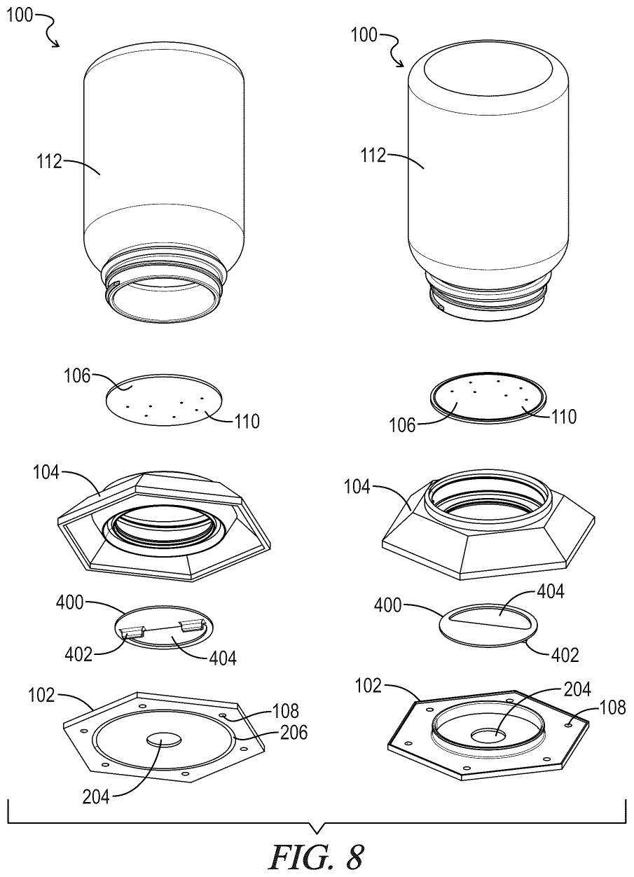

Referring to FIG. 8, a liquid feed container 112, such as a jar, may provide liquid storage and dispensing functionality for the liquid dispensing top feeder device 100. The liquid feed container 112 may be configured to hold liquid feed such as sugar-water mixtures or other nutritional solutions for honey bee colonies. In some cases, the liquid feed container 112 may be positioned above the base plate 102 and may interface with the riser 104. The liquid feed container 112 may be inverted during operation, allowing liquid feed to be accessible through the plurality of holes 110 in the dispensing plate 106 based on the positioning of the shutter 400. The liquid feed container 112 may work in conjunction with other components of the liquid dispensing top feeder device 100 to provide adjustable feed delivery rates while maintaining secure mounting to hive structures.

With continued reference to FIG. 8, the dispensing plate 106 may be positioned to interface with the riser 104 in the assembled configuration of the liquid dispensing top feeder device 100. The dispensing plate 106 may be secured between the riser 104 and the feeding container, creating a controlled dispensing interface that regulates liquid flow from the feeding container through the plurality of holes 110. In some aspects, the positioning of the dispensing plate 106 between the riser 104 and the feeding container may allow for proper alignment of flow control components while maintaining secure connections between all elements of the liquid dispensing top feeder device 100. The dispensing plate 106 may be configured to maintain its position during operation while allowing for adjustment of flow control mechanisms such as the shutter 400 that may be positioned adjacent to the dispensing plate 106.

The liquid dispensing top feeder device 100 may be compatible with various types of feeding containers, providing flexibility for beekeepers with different operational requirements and container preferences. In some aspects, this compatibility may allow beekeepers to utilize mason jars as feeding containers, which may provide convenient sizing options and readily available threading configurations that mate with the riser threads 302 of the riser 104. The threading interface between the liquid feed container 112 and the riser 104 may provide a watertight seal that prevents liquid leakage while allowing for easy assembly and disassembly of the liquid dispensing top feeder device 100.

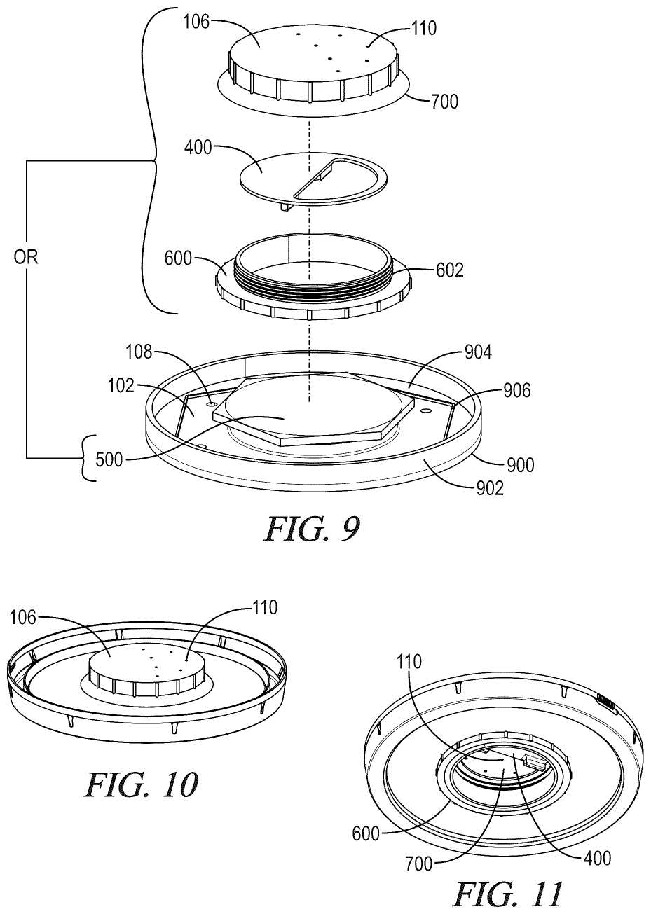

Referring to FIG. 9, the liquid feed container 112 may alternatively comprise bucket configurations that interface with the liquid dispensing top feeder device 100 through different mounting arrangements. In some aspects, the liquid feed container 112 may be a plastic bucket feeding container which may provide larger capacity options for extended feeding operations or larger bee colonies that consume liquid feed at higher rates. The liquid feed container 112 may be configured to interface with additional or alternative components, such as nut 600, cap 700, adapter plate 900, and/or specialized mounting hardware that accommodate the different structural characteristics of bucket-style containers compared to mason jar configurations.

The liquid feed container 112 may be configured to interface with the central opening 204 of the base plate 102, allowing bees to access liquid feed from the hive environment below. The positioning of feeding containers relative to the central opening 204 may create a controlled feeding zone where bees can access liquid feed at rates determined by the positioning of the shutter 400. In some cases, the interface between feeding containers and the base plate 102 may be designed to prevent direct dripping of liquid feed into the hive environment. Additionally, the inversion of a feeding container may create a vacuum within the container that prevents or inhibits the flow of liquid feed. The feeding container interface may work in conjunction with the groove 206 and sealing features of the base plate 102 to minimize moisture intrusion into the hive while providing controlled access to liquid nutrition for bee colonies.

With continuing reference to FIG. 9, the adapter plate 900 may provide enhanced structural support and stability for the liquid dispensing top feeder device 100 when used with larger liquid feed containers 112, such as plastic buckets. The adapter plate 900 may be disposed around the base plate 102, creating an expanded mounting platform that distributes the weight of larger feeding containers across a broader surface area. In some cases, the adapter plate 900 may serve as an intermediate mounting element that interfaces between the base plate 102 and bucket-style feeding containers, providing additional stability during feeding operations. The adapter plate 900 may be configured to accommodate the different structural characteristics and weight distributions associated with larger capacity feeding containers while maintaining the controlled dispensing functionality provided by other components of the liquid dispensing top feeder device 100. The positioning of the adapter plate 900 around the base plate 102 may create a stable foundation that prevents tipping or displacement of feeding containers during extended feeding operations or when exposed to environmental conditions such as wind or vibration.

The adapter plate 900 may be cylindrical in shape, which may provide uniform load distribution around the perimeter of the base plate 102 while maintaining compatibility with various bucket sizes and configurations. In some aspects, the cylindrical configuration of the adapter plate 900 may facilitate proper alignment with the base plate 102 during installation, ensuring that the adapter plate 900 is positioned concentrically around the base plate 102. In some cases, the cylindrical shape may allow the adapter plate 900 to accommodate slight variations in base plate 102 dimensions or positioning while maintaining proper support functionality for feeding containers.

As further shown in FIG. 9, the adapter plate 900 may comprise a raised exterior edge 902 around a perimeter thereof. The raised exterior edge 902 may provide a containment feature that helps position feeding containers relative to the adapter plate 900 while preventing lateral movement during operation. In some cases, the raised exterior edge 902 may create a shallow recess or depression within the adapter plate 900 that accommodates the bottom surface of feeding containers, providing improved stability and positioning accuracy. The raised exterior edge 902 may extend upward from the main surface of the adapter plate 900, creating a rim or border that guides the placement of feeding containers and maintains proper alignment with the base plate 102 and associated dispensing components. The height and configuration of the raised exterior edge 902 may be selected to provide adequate containment functionality while allowing for easy placement and removal of feeding containers during assembly and maintenance operations. The raised exterior edge 902 may extend continuously around the entire perimeter of the adapter plate 900, creating a uniform containment interface that provides consistent support regardless of the rotational orientation of feeding containers relative to the adapter plate 900.

The adapter plate 900 may comprise a first opening 906 in a base of the adapter plate 900 connected to the raised exterior edge 902 by an adapter plate base 904. The first opening 906 may be hexagonal in shape, may be positioned at the center of the adapter plate 900, and may be configured to accommodate the hexagonal shape of the base plate 102, providing proper alignment and positioning between these components during assembly. In some aspects, the hexagonal configuration of the first opening 906 may prevent rotational movement between the adapter plate 900 and the base plate 102, maintaining consistent positioning of these components relative to each other during operation. The adapter plate base 904 may extend radially outward from the first opening 906 toward the raised exterior edge 902, creating a series of apertures or channels that reduce the overall weight of the adapter plate 900 while maintaining structural integrity. The adapter plate base 904 may include a symmetrical configuration that provides balanced load distribution across the adapter plate 900 while allowing for material savings and improved manufacturing efficiency. The adapter plate base 904 and the empty space created by the raised exterior edge 902 of the adapter plate 900 may provide a buffer that helps protect bee colonies by preventing smells, pests, and other potentially harmful environmental factors from accessing the hive or device.

In some aspects, the adapter plate base 904 may comprise a series of structural ribs or supports that connect the first opening 906 to the raised exterior edge 902, providing load transfer paths that distribute the weight of feeding containers across the adapter plate 900 structure. The openings within the adapter plate base 904 may be sized and positioned to maintain adequate structural strength while providing weight reduction benefits that facilitate handling and installation of the adapter plate 900. The adapter plate base 904 may be arranged in geometric configurations such as radial spokes, concentric rings, or other patterns that optimize the balance between structural performance and material efficiency. In some cases, the adapter plate base 904 may provide visual indicators that assist with proper alignment of the adapter plate 900 relative to the base plate 102 during assembly operations, ensuring that the hexagonal opening is properly positioned relative to the hexagonal shape of the base plate 102.

The adapter plate base 904 may comprise a repetitive pattern of hexagons or other geometric shapes that extend across the surface of the adapter plate 900. In some aspects, the repetitive hexagonal pattern may provide uniform structural characteristics while creating a visually consistent design that complements the hexagonal configuration of the base plate 102. The hexagonal openings within the pattern may be arranged in a honeycomb-like configuration that enhances material efficiency while maintaining structural integrity across the adapter plate 900. In some cases, the adapter plate base 904 may alternatively comprise repetitive patterns of other geometric shapes, such as circles, triangles, squares, or elongated slots that provide similar structural and functional benefits. The selection of specific geometric shapes for the repetitive pattern may be based on factors such as manufacturing considerations, structural performance requirements, or aesthetic preferences while maintaining the load distribution and weight reduction functionality of the adapter plate 900. Alternatively, the adapter plate base 904 may be solid in design.

The adapter plate 900 may be positioned to interface with both the base plate 102 and larger feeding containers in the assembled configuration of the liquid dispensing top feeder device 100. The adapter plate 900 may rest on the hive cover or mounting surface adjacent to the base plate 102, creating an expanded platform that accommodates the larger footprint of bucket-style feeding containers. In some aspects, the adapter plate 900 may be configured to maintain proper spacing between the feeding container and the base plate 102, ensuring that the cap 700 and associated dispensing components are positioned correctly relative to the central opening 204 for controlled liquid delivery. The interface between the adapter plate 900 and the base plate 102 may allow for proper alignment of dispensing components while providing enhanced stability for larger capacity feeding operations. The adapter plate 900 may work in conjunction with the nut 600 and cap 700 to create a complete mounting system that accommodates bucket-style feeding containers while maintaining the controlled dispensing functionality provided by the shutter 400 and the plurality of holes 110.

The adapter plate 900 may be formed of weather-resistant, UV-resistant, and heat-resistant materials that are environmentally friendly, of food-grade quality, and easily cleanable. For example, the adapter plate 900 may be formed using 3D printing with ASA (acrylonitrile styrene acrylate) plastic, which may provide weather resistance, UV stability, and heat resistance while maintaining food-grade compatibility for bee feeding applications. Alternatively, the adapter plate 900 may be formed using injection molding with HDPE (high-density polyethylene), which offers environmental resistance, UV protection, and food-grade safety for extended outdoor use in beekeeping applications. The material selection for the adapter plate 900 may provide appropriate structural strength to support the weight of larger feeding containers while maintaining dimensional stability under varying environmental conditions. In some cases, the plastic construction of the adapter plate 900 may provide corrosion resistance and long-term durability when exposed to sugar-water mixtures and outdoor environmental conditions commonly encountered in beekeeping applications. The adapter plate 900 may be configured to maintain its structural properties and dimensional accuracy over extended periods of use, which may reduce maintenance requirements and provide reliable support functionality throughout multiple feeding cycles.

Referring to FIGS. 10 through 13, the cap 700 may be positioned relative to other components of the liquid dispensing top feeder device 100 to demonstrate the bucket feeder configuration. The cap 700 may interface with the nut 600 through the threaded connection, creating a controlled dispensing mechanism that may be attached to the lid of bucket-style feeding containers. In some aspects, the cap 700 may be positioned above the adapter plate 900 when the liquid dispensing top feeder device 100 is configured for bucket feeding applications, allowing the bucket container to rest on the adapter plate 900 while maintaining controlled liquid dispensing through the plurality of holes 110. The positioning of the cap 700 relative to the base plate 102 may create a controlled feeding zone where bees can access liquid feed at rates determined by the positioning of the shutter 400 relative to the plurality of holes 110 in the cap 700.

Referring to FIGS. 10 and 11, the bucket feeder configuration may be assembled by first attaching the nut 600 and cap 700 to the bucket lid. The nut 600 may be inserted through a hole drilled in the bucket lid, with the nut flared base 604 positioned against the topside of the lid. The cap 700 may then be threaded onto the nut 600 using the cap threads 702 and nut threads 602, creating a secure connection that sandwiches the bucket lid between these components. As seen in FIG. 11, the shutter 400 may be positioned in the cap 700 prior to assembly, allowing for rotational adjustment to control the exposure of the plurality of holes 110 in the cap 700.

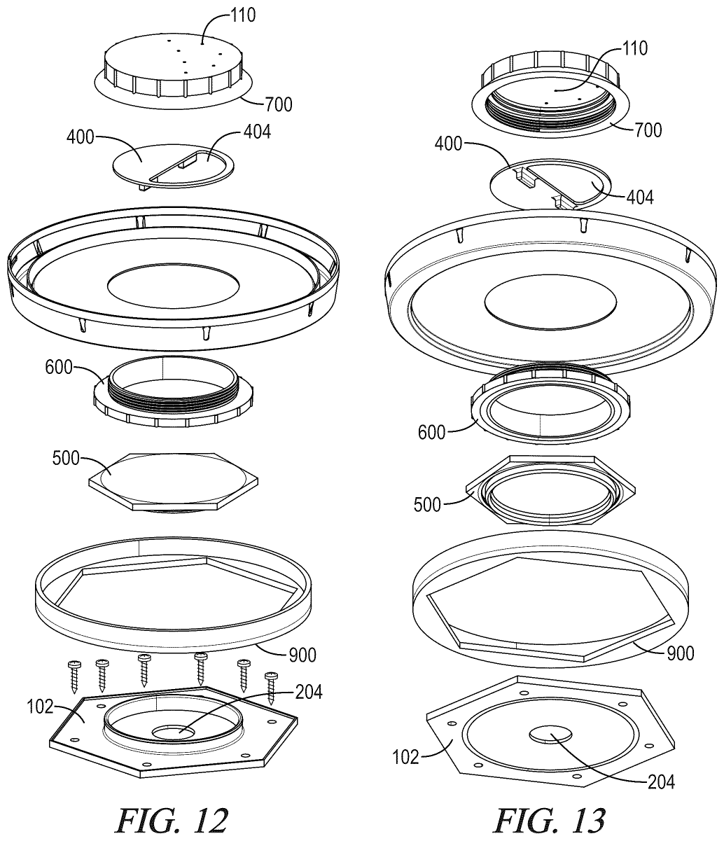

Referring to FIGS. 12 and 13, bucket feeding installations may involve different preparation and assembly procedures that accommodate the larger size and different structural characteristics of bucket-style containers. The bucket lid preparation may begin with drilling a hole in the bucket lid to accommodate the nut 600 component. The hole may be approximately three to three and one-eighth inches in diameter. The hole drilling operation may be performed using appropriate cutting tools, with the hole diameter selected to provide a proper fit for the nut 600 while maintaining adequate material around the hole perimeter for structural support. In some aspects, the hole positioning may be centered on the bucket lid to provide balanced weight distribution and enhanced liquid dispensing characteristics. The hole edges may be smoothed or deburred following the drilling operation to ensure proper sealing and to prevent damage to sealing materials during assembly.

Nut 600 installation procedures may involve sealing operations that prevent liquid leakage at the connection between the nut 600 and the bucket lid. A line of sealant, such as a one-eighth-inch line of sealant, may be applied to the nut 600 prior to insertion through the bucket lid hole. The sealant application may be performed around the nut 600, nut threads 602, or other sealing surfaces that will contact the bucket lid material during installation. In some cases, the sealant may comprise silicone-based or other flexible sealing compounds that maintain sealing performance under the mechanical loads and environmental conditions associated with bucket feeding operations. The nut 600 may be inserted through the bucket lid, a sealant may then be applied, and the cap 700 may be threaded onto the nut 600, creating a sealed connection that prevents liquid leakage. The nut 600 positioning may ensure that the threaded portion extends through the bucket lid to provide adequate engagement length for the cap 700 attachment while maintaining proper sealing at the lid interface.

The cap 700 having a plurality of holes 110 may be attached to the nut 600 with the shutter 400, if not integrated into the cap 700, positioned between the cap 700 and the nut 600. The shutter 400 positioning may be performed prior to cap 700 installation, ensuring that the shutter 400 is properly aligned relative to the plurality of holes 110 in the cap 700 for effective flow control functionality. In some aspects, the shutter 400 may be positioned within the cap 700, depending on the specific design configuration of the bucket feeding system. The cap 700 may be threaded onto the nut 600 using the threaded interfaces provided on both components, creating a secure connection that maintains proper positioning of the shutter 400 and sealing of the liquid dispensing system. The threading operation may be performed by hand-tightening the cap 700 to the nut 600 until the connection is flush with the bucket lid surface, ensuring adequate compression of sealing materials while maintaining accessibility to shutter adjustment features.

Excess sealant that may be squeezed out during the cap 700 installation process may be removed from both sides of the bucket lid to maintain clean appearance and prevent interference with other components. The sealant removal may be performed using appropriate tools or materials that do not damage the sealing integrity of the installed components. Following sealant cleanup, the assembly may be allowed to cure according to the sealant manufacturer's recommendations, ensuring that the sealing materials achieve full strength and sealing performance before the feeding system is placed into operation. In some cases, the curing time may vary based on environmental conditions such as temperature and humidity, with adequate curing time allowing for reliable sealing performance throughout extended feeding operations.

Once the cap 700, nut 600, and shutter 400 assembly is secured to the bucket lid, the filled bucket may be inverted and positioned on the base plate 102 and adapter plate 900. The adapter plate 900 may provide a stable platform that accommodates the larger footprint of bucket-style containers, while the raised exterior edge 902 helps contain and position the inverted bucket. The cap 700 may align with the central opening 204 of the base plate 102, creating a controlled dispensing interface where liquid feed can be accessed by bees from the hive environment below. The shutter 400 may be adjusted to regulate the feed delivery rate by varying the amount of overlap between the semicircular opening 404 and the plurality of holes 110 in the cap 700, providing precise control over liquid dispensing throughout the feeding operation.

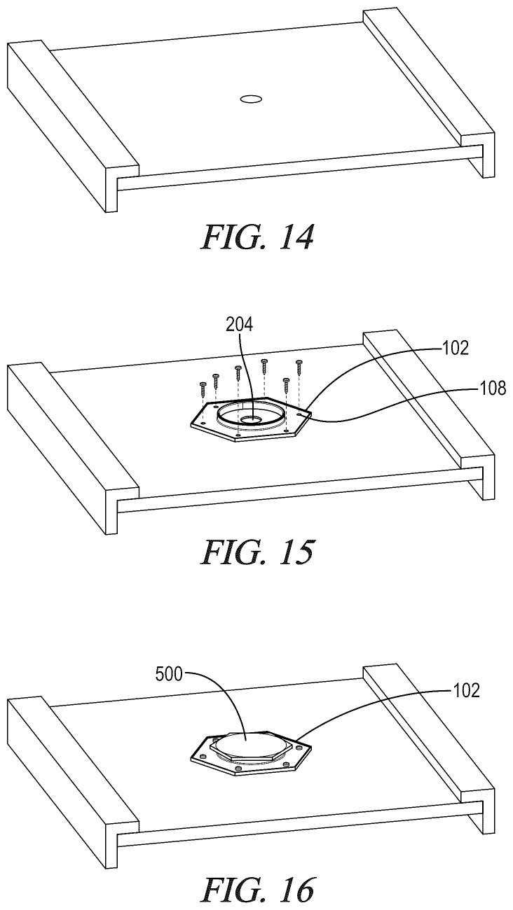

The liquid dispensing top feeder device may be installed and operated using various methods that accommodate different feeding container types and hive configurations. Installation procedures may begin with preparation of the hive cover to accept the base plate mounting system. As seen in FIG. 14, the hive cover may be modified by drilling a hole, such as a one-inch hole, that provides access for bees while accommodating the central opening 204 of the base plate 102. The drilling operation may be performed using standard tools, with the hole positioned to align with the desired feeding location relative to the bee colony below. In some cases, the hole diameter may be selected to provide adequate bee access while maintaining structural integrity of the hive cover. The positioning of the hole may take into account factors such as hive geometry, bee traffic patterns, and accessibility for maintenance operations.

Mounting of the base plate 102 to the hive cover may involve sealing procedures that prevent moisture intrusion into the hive environment. A quarter inch of caulk may be applied throughout the groove 206 on the bottom of the base plate 102 to create a watertight seal between the base plate 102 and the hive cover surface. The caulk application may be performed using standard caulking tools, with the sealant distributed evenly throughout the groove 206 to ensure complete coverage and effective sealing performance. In some aspects, the caulk may comprise silicone-based or polyurethane-based sealants that provide flexibility and long-term adhesion to both the base plate material and the hive cover surface. The groove 206 configuration may retain the caulk during installation while allowing for proper compression when the base plate 102 is secured to the hive cover. The central opening 204 of the base plate 102 may be aligned over the hole in the hive cover, ensuring proper positioning for bee access and liquid dispensing functionality, as shown in FIG. 15.

The base plate 102 may be attached to the hive cover using a plurality of screws that engage with the mounting holes 108 disposed around the base plate perimeter. The screws may be driven through the mounting holes 108 into the hive cover material, creating a secure mechanical connection that maintains proper positioning of the base plate 102 during feeding operations. In some cases, the screw installation may compress the caulk within the groove 206, creating an effective seal that prevents moisture leakage around the base plate perimeter. The screw tightening process may be performed gradually and evenly across all mounting points to ensure uniform compression of the sealing caulk and proper distribution of mounting loads. The completed base plate installation may provide a stable platform for supporting feeding containers while maintaining environmental isolation between the feeding system and the hive interior.

As shown in FIG. 16, the plug 500 may be used to seal the central opening 204 of the base plate 102 when the feeding container is not in use. In some aspects, the plug 500 may create an environmental barrier that maintains hive conditions by blocking moisture intrusion, temperature fluctuations, or pest access through the central opening 204 when the feeder is not in use. The plug 500 may be easily removed when feeding operations are to be resumed, allowing for a convenient transition between feeding and non-feeding periods without requiring disassembly of the base plate 102 from the hive cover.

Mason jar feeding operations may involve specific assembly procedures that utilize the threaded connection capabilities of the riser 104 component. The feeding container may be filled with the desired liquid, such as a sugar-water mixture, prior to assembly operations to ensure proper liquid levels and mixture consistency. The sugar-water mixture may be prepared according to beekeeping practices, with concentration levels selected based on seasonal conditions, colony needs, and feeding objectives. In some aspects, the liquid mixture may be prepared using clean water and appropriate sugar ratios that provide nutritional value without promoting fermentation or contamination. The filled mason jar may be prepared for assembly by ensuring that the jar threads are clean and free from debris that could interfere with proper sealing or threading operations.

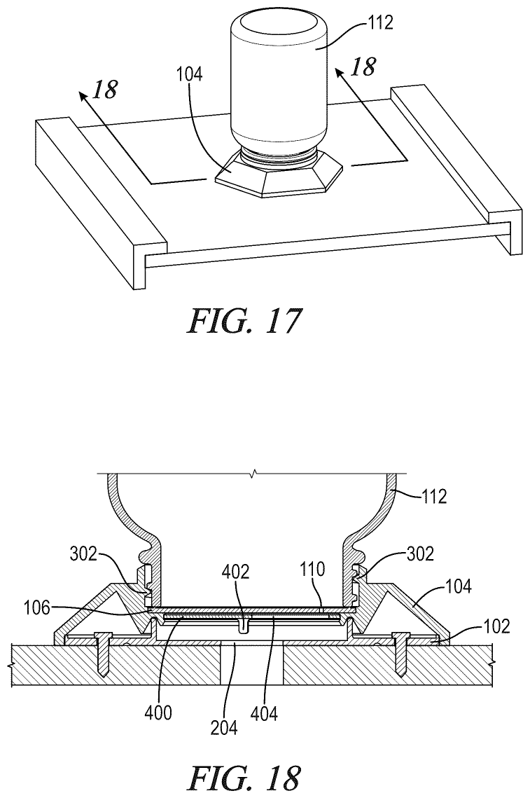

As shown in FIGS. 17 and 18, the dispensing plate 106 having a plurality of holes 110 and the riser 104 may be placed in contact with the feeding container, creating a controlled dispensing interface between the liquid contents and the external environment. The dispensing plate 106 positioning may ensure that the plurality of holes 110 are properly aligned relative to the container opening while maintaining adequate sealing around the container rim. The shutter 400 may be positioned adjacent to the dispensing plate 106, creating an adjustable flow control mechanism that can regulate the exposure of the plurality of holes 110 based on rotational positioning. In some cases, the shutter 400 positioning may be performed with the shutter 400 attached to the riser 104 below the dispensing plate 106 in a closed or minimal flow configuration to prevent liquid spillage during assembly operations. The riser 104 may be threaded onto the mason jar, securing the riser 104 and the dispensing plate 106 to the mason jar through the threaded connection. The threading operation may be performed by hand-tightening the riser 104 onto the jar threads, creating adequate compression to secure the riser 104 while maintaining the ability to adjust shutter 400 positioning for flow control beneath the dispensing plate 106.

Flow rate adjustment may be accomplished by rotating the shutter 400 to expose a desired number of the plurality of holes 110 in the dispensing plate 106. The shutter 400 rotation may be performed using the one or more tabs 402 or grip features provided on the shutter 400, allowing beekeepers to adjust the overlap between the semicircular opening 404 and the plurality of holes 110 in the dispensing plate 106. In some aspects, the rotational adjustment may provide a range of flow control options, from minimal liquid dispensing to maximum flow rates based on the degree of hole exposure. The shutter 400 positioning may be adjusted based on factors such as colony size, seasonal feeding requirements, environmental conditions, and observed consumption rates. The ability to adjust flow rates without disassembling the feeding system may provide operational convenience while allowing for responsive management of feeding operations based on changing colony conditions.

The assembled mason jar feeding system, including the riser 104, the dispensing plate 106, and the shutter 400, may be inverted and placed on the base plate 102 to allow access to the liquid feed at a controlled rate. The inversion process may be performed carefully to prevent liquid spillage while ensuring that the feeding container is properly positioned relative to the base plate 102 central opening 204. In some cases, the inverted positioning may create a vacuum effect within the feeding container that regulates liquid flow through the exposed holes in the dispensing plate 106 based on atmospheric pressure and liquid level within the container. The feeding container placement on the base plate 102 may ensure stable positioning while allowing bees to access the dispensed liquid through the central opening 204 from the hive environment below. The controlled dispensing rate may be maintained throughout the feeding operation based on the shutter positioning and the physical characteristics of the liquid mixture.

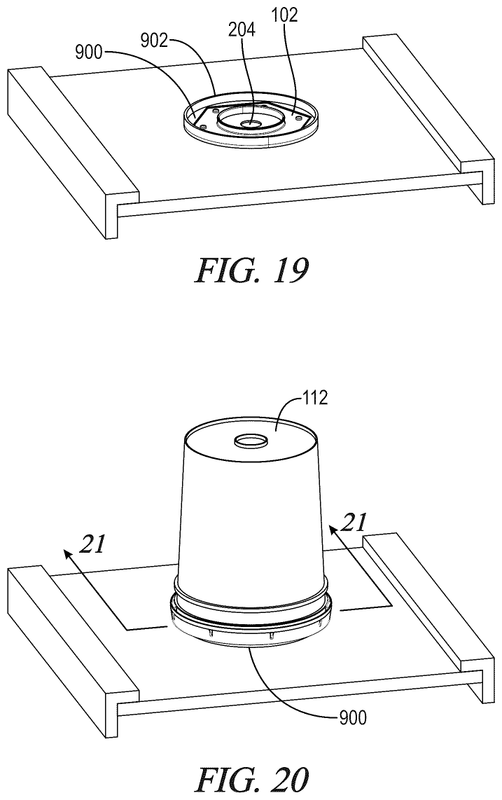

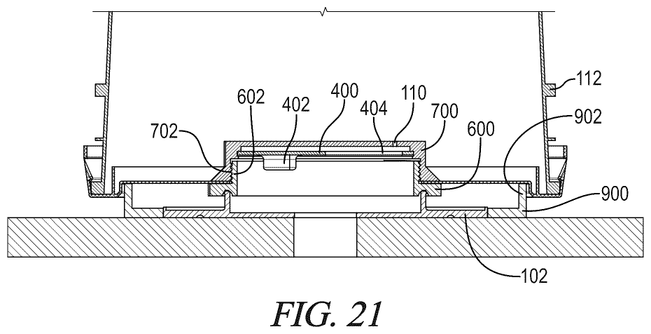

As shown in FIGS. 19 through 21, bucket feeding operations may involve additional preparation steps that accommodate the larger capacity and different mounting requirements of bucket-style containers. An adapter plate 900 may be positioned around the base plate 102 before placing the bucket feeding container on the base plate 102, as seen in FIG. 19. The adapter plate 900 positioning may create an expanded support platform that distributes the weight of larger feeding containers while maintaining proper alignment with the base plate central opening 204. In some aspects, the adapter plate installation may involve aligning the first opening 906 in the adapter plate 900 with the hexagonal shape of the base plate 102, ensuring proper positioning and preventing rotational movement between these components during operation. The adapter plate 900 may rest on the hive cover surface adjacent to the base plate 102, creating a stable foundation that accommodates the larger footprint of bucket-style feeding containers.

After attaching the cap 700, nut 600, and shutter 400 to the bucket feeder, the filled bucket feeding container may be inverted and placed on the adapter plate 900 and base plate 102 assembly to initiate controlled liquid dispensing operations, as seen in FIG. 20. The bucket inversion process may be performed with care to prevent liquid spillage while ensuring that the cap 700 and dispensing components are properly positioned relative to the base plate central opening 204. In some cases, the larger capacity of bucket containers may provide extended feeding duration compared to mason jar configurations, reducing the frequency of refilling operations while maintaining controlled dispensing rates based on shutter positioning. The bucket placement on the adapter plate 900 may ensure stable positioning while allowing the dispensing system to function properly throughout extended feeding cycles. The controlled dispensing functionality may be maintained through adjustment of the shutter 400 position relative to the plurality of holes 110 in the cap 700, providing the same flow control capabilities available with mason jar feeding configurations while accommodating the different structural and capacity characteristics of bucket-style feeding containers.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously, many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

Thus, although there have been described particular embodiments of the present invention of a new and useful Liquid Dispensing Top Feeder it is not intended that such references be construed as limitations upon the scope of this invention except as set forth in the following claims.

1. A liquid dispensing top feeder device, comprising:
a base plate having a central opening;
a riser configured to attach to a feeding container;
a dispensing plate having a plurality of holes and configured to be disposed between the riser and the feeding container; and
a shutter disposed adjacent the dispensing plate, wherein the shutter is rotatable to selectively expose different amounts of the plurality of holes in dispensing plate lid to control a feed delivery rate.

2. The liquid dispensing top feeder device of claim 1, wherein the base plate comprises a groove configured to receive a sealant.

3. The liquid dispensing top feeder device of claim 1, wherein the base plate is hexagonal in shape and comprises a plurality of mounting holes spaced around the base plate for securing the base plate.

4. The liquid dispensing top feeder device of claim 1, wherein the riser comprises a cylindrical portion having threads configured to engage with threads of the feeding container.

5. The liquid dispensing top feeder device of claim 1, wherein the riser further comprises a flared base configured to rest on the base plate.

6. The liquid dispensing top feeder device of claim 1, wherein the shutter comprises a circular disk having an opening disposed on a first side thereof, and wherein rotation of the shutter varies an amount of overlap between the opening and the plurality of holes in the dispensing plate.

7. The liquid dispensing top feeder device of claim 6, wherein the opening in the shutter is semicircular in shape.

8. The liquid dispensing top feeder device of claim 1, wherein the shutter has one or more tabs.

9. A liquid dispensing top feeder device, comprising:
a base plate having a central opening and configured to mount on a hive cover;
an adapter plate disposed around the base plate;
a nut configured to be inserted into a feeding container lid;
a cap having a plurality of holes and configured to attach to the nut; and
a shutter disposed between the cap and the nut, wherein the shutter is rotatable to selectively expose different amounts of the plurality of holes in the cap to control a feed delivery rate.

10. The liquid dispensing top feeder device of claim 9, wherein the base plate comprises a groove configured to receive a sealant for creating a watertight seal with the hive cover.

11. The liquid dispensing top feeder device of claim 10, wherein the base plate is hexagonal in shape and comprises a plurality of mounting holes spaced around the base plate for securing the base plate.

12. The liquid dispensing top feeder device of claim 9, wherein the adapter plate is cylindrical in shape and comprises a raised exterior edge around a perimeter thereof.

13. The liquid dispensing top feeder device of claim 9, wherein the adapter plate comprises a first opening in a base of the adapter plate connected to a raised exterior edge by a pattern of openings.

14. The liquid dispensing top feeder device of claim 9, wherein the nut comprises a cylindrical shape with a flared base having fins disposed around the flared base.

15. The liquid dispensing top feeder device of claim 9, wherein the cap is cylindrical in shape and comprises fins disposed around edges of the cap, and wherein the cap comprises threads configured to engage with corresponding threads of the nut.

16. A method of using a liquid dispensing top feeder device, comprising:
mounting a base plate having a central opening to a hive cover;
attaching a dispensing plate or a cap having a plurality of holes to a feeding container;
positioning a shutter adjacent to the dispensing plate or cap;
rotating the shutter to expose a desired number of the plurality of holes in the dispensing plate or cap; and
inverting the feeding container and placing it above the base plate and the central opening to dispense liquid feed at a controlled rate.

17. The method of claim 16, wherein mounting the base plate comprises drilling a one-inch hole in the hive cover and applying sealant in a groove on a bottom of the base plate before securing the base plate to the hive cover.

18. The method of claim 16, wherein the feeding container is a mason jar, and the method further comprises attaching a riser to the feeding container to secure the dispensing plate between the mason jar and the riser.

19. The method of claim 16, wherein the feeding container is a bucket and the method further comprises drilling a hole in a bucket lid, inserting a nut through the bucket lid hole, applying a sealant, and attaching the cap having the plurality of holes to the nut with the shutter positioned between the cap and the nut.

20. The method of claim 19, further comprising a step of positioning an adapter plate around the base plate before placing the feeding container on the base plate.
